(19) United States
(12) Patent Application Publication
(10) Pub. No.: US 2008/0059216 A1
(43) Pub. Date: Mar. 6, 2008

(54) Protection and Monitoring of Content Diffusion in a Telecommunications Network

(75) Inventors: Gael Fromentoux, Pleuemeur-Bodou (FR); Eric Barault, Perros Guirec (FR); Nicolas Bihannic, Trebeurden (FR)

Correspondence Address: COHEN, PONTANI, LIEBERMAN & PAVANE, 551 FIFTH AVENUE, SUITE 1210, NEW YORK, NY, 10176, US

(73) Assignee: France Telecom, Paris (FR)

(21) Appl. No.: 11/662,148

(22) PCT Filed: Sep. 6, 2005
(86) PCT No.: PCT/FR05/02217

§ 371 Date: Nov. 13, 2007

(30) Foreign Application Priority Data
Sep. 7, 2004 (FR) 0451981

(51) Int. Cl. G06Q 10/00; G06F 17/00; G06Q 99/00

(52) U.S. Cl. 705/1

(57) ABSTRACT

The invention relates to supervising the distribution of contents in a telecommunications network (R). A content contains data specific to a given acquisition of rights to the content, written in the form of a digital watermark (WM). During its transfer across an access network (RA), the content is analyzed to detect the presence of a digital watermark. The data specific to the acquisition is then extracted from the watermark and sent with data characteristic of the transfer in progress to central supervisory equipment (300) of the telecommunications network (R) in order to determine if the transfer in progress is legitimate.

The present invention relates to protecting and monitoring the distribution of contents over telecommunications networks.

The field of the invention is that of telecommunications networks for the monitored distribution of multimedia contents. The invention aims to guarantee multimedia content providers that the distribution of their content over telecommunications networks is supervised, monitored, and notified.

In the present context of increasing Internet connection rates and the increasing success of on-line retailing, there has been a considerable increase in exchange of contents over the Internet. Thus a large number of multimedia contents are purchased once only from a content provider and then distributed to many users over the Internet free of charge, in contravention of the rights attached to those contents.

Peer-to-peer architectures allow this free exchange of contents and therefore encourage piracy. These architectures are made possible by the Internet Protocol (IP). They enable multimedia contents to be made available to everyone. To do this, users seeking to make resources that are available on their terminal available to other surfers install a program enabling them to do this and place in a dedicated space of their terminal all the contents that they are inclined to exchange. These architectures are also finding their way into the world of mobile networks.

In the context of the fight against piracy, it must therefore be possible to guarantee to content providers that the rights associated with the contents will be protected and to end users that the contents that they wish to transfer to their terminal are legitimate.

Moreover, the solution for supervising the distribution of multimedia contents in telecommunications networks must be able to adapt to any kind of architecture, whether of the client-server or peer-to-peer type, for example.

Many techniques for encrypting information and associated transfer mechanisms are now available. However, those solutions do not integrate all of the requirements of a complex environment. In fact, those solutions are very difficult to implement when multimedia contents are transferred over more than one type of access network. Moreover, those solutions are no longer of benefit once the onboard algorithms have been pirated.

The Open Mobile Alliance (OMA), which is an industry forum created in June 2002, has in particular specified mechanisms to regulate the transport of content for mobile networks only, which mechanisms are based on the use of digital rights management (DRM). DRM is based on a mechanism that identifies each content digitally, lists it, and monitors its use on a network, in particular in order to be able to prevent unauthorized copying and to make on-line distribution of multimedia works secure.

The OMA imposes very heavy constraints on the hardware and the software, however, and requires a very closed environment. In fact, in this configuration, telecoms operators must manage their network end to end. Security systems are installed in the mobile telephones, for example, and users then do not have control of their terminals. That solution is therefore difficult to transpose to an open environment in which a user can easily access the memory of a terminal, reconfigure it, install new software in it, and break the security system that is installed in it. Moreover, in this type of open environment, such as the Internet, for example, whether they be computers, personal digital assistants, or whatever, terminals are connected via multiple access networks. Consequently, in an open environment, with constantly evolving security mechanisms, it is necessary to install the security systems in the network rather than in the terminals.

Moreover, the solutions proposed by the OMA are limited in the sense that they are not adapted to all mobility and roaming situations, in particular in a context of multiple technologies and multiple access networks. In fact, they limit the transfer of a multimedia content to a few mobile network access technologies. For example, a multimedia content that can be used via a GSM network is not at present usable via a WLAN access network because of rights notification mechanisms that are not supported via a WLAN access network.

Digital watermarking, also known as digital tattooing, is another well-known marking technique and consists in inserting an invisible and permanent signature into contents in transit in the network. This marking remains imperceptible to and undetectable by any system ignorant of its mode of insertion. However, in themselves, those techniques are not able to monitor exchanges between users. They serve rather to prove piracy a posteriori, but it is then necessary to prove that a user has obtained the content illegitimately and to find the watermark in the copy of the originally marked content. Thus those techniques cannot provide real-time monitoring of contents exchanged over a telecommunications network.

It is therefore very difficult at present to monitor the distribution and exchange of contents over the Internet and to prevent piracy.

Thus the technical problem addressed by the present invention is to propose a method and a system for supervising the distribution of contents in a telecommunications network that would make it possible to detect illegitimate transfer of contents in real time.

To this end, the present invention consists in a method of supervising the distribution of a content in a telecommunications network when data specific to a given acquisition of rights to the content has been written therein, consisting in effecting the following processing of the content during its transfer over the telecommunications network:
analyzing the content and extracting the data specific to said acquisition therefrom with the aid of a detection probe situated in the telecommunications network;
accessing the acquired rights to the content in a storage medium with the aid of the extracted data specific to the acquisition; and
determining if the transfer of the content in progress is legitimate.

Thus, with the aid of a probe situated in the network, the invention consists in detecting data specific to a given acquisition in a content that is in the process of being transferred, and in extracting it on the fly. Detection is therefore effected globally in the network rather than individually by the terminals. The probe is preferably placed in the network at a point through which the content is obliged to pass, for example in the access network.

For example, there is advantageously a step of sending the data specific to the acquisition extracted from the content and data characteristic of the transfer in progress from the probe to central supervisory equipment of the telecommunications network to determine the legitimacy of the transfer in progress. The data characteristic of the transfer includes the source and destination addresses of the content distributed, the time and date, etc.

When it has been extracted from the content by the probe, the data specific to the acquisition is then sent in real time to central supervisory equipment installed in the telecommunications network, which has the role of ruling on the legitimacy of the transfers in progress. Thus the operation of determining if the transfer in progress is legitimate is carried out in a centralized manner, on the basis of information sent by detection probes situated in the network.

The step of analyzing the content and extracting therefrom the data specific to the acquisition is preferably executed in an access network of the telecommunications network. Installing the probe in the access network makes it certain that the passage of the content in the network can be detected.

The data characteristic of the transfer in progress advantageously includes characteristics of the access network.

A user may have several access points to the network, of the same or different types (mobile, WLAN, fixed dial-up, fixed broadband, etc.). Under such circumstances, the user may wish to have different rights to the content depending on the access point used or, to the contrary, to have the same rights to the content for at least two different access points. Users authorized to use the content from their access point in accordance with the rights defined by the acquirer at the time of acquisition can also have respective different access points. To enable refined management of users' rights to contents if different network access points are used, the probe sends characteristics of the access network to the central supervisory equipment, enabling it to determine the access network used.

The invention also consists in:
a detection probe for a telecommunications network, adapted to implement a detection mechanism consisting, during the transfer over said network of a content in which data specific to a given acquisition of rights to said content has been written, in analyzing the content and extracting therefrom the data specific to the acquisition;
central equipment for supervising the distribution of contents in a telecommunications network, adapted:
   to monitor the incorporation into a content to be distributed of data specific to a given acquisition of rights to said content; and
   during transfer of the content over the network, to obtain from a detection probe the data specific to the acquisition extracted from the content and with the aid of that data to access the acquired rights to the content in a storage medium in order to determine if the transfer of the content in progress is legitimate;
a storage medium for storing data relating to acquisition of rights to contents comprising, for a given acquisition, characteristics relating to the content and data relating to the acquired rights to the content comprising, for a user, an access point to the telecommunications network and rights to the content;
a service provider of a telecommunications network, comprising:
   central supervisory equipment as defined above situated in the telecommunications network;
   a storage medium for data relating to acquisition of rights to contents; and
   a watermarking module adapted to write data specific to a given acquisition of rights to a content in said content to be distributed on the basis of data stored in said storage medium; and
a system for supervising the distribution of contents in a telecommunications network, comprising a service provider as defined above and a detection probe as defined above.

The central supervisory equipment installed in the telecommunications network monitors the incorporation of the data specific to the acquisition in the contents to be distributed to protect them and receives data from one or more detection probes installed in the network—preferably in the access networks—in order to determine if a transfer in progress is legitimate. This equipment uses the received data specific to a given acquisition to access the data stored in the storage medium, which data associates characteristics of the content and users' network access points and each user's rights to the content. This data is defined at the time of acquisition of a content by an acquirer. Given the data characteristic of the transfer in progress and data stored in the storage medium, the central supervisory equipment determines if the rights associated with a content distributed over the network have been contravened and, if so, recognizes that the transfer in progress is illegitimate.

Other features and advantages of the invention become apparent on reading the following description given by way of illustrative and non-limiting example with reference to the appended drawings, in which:

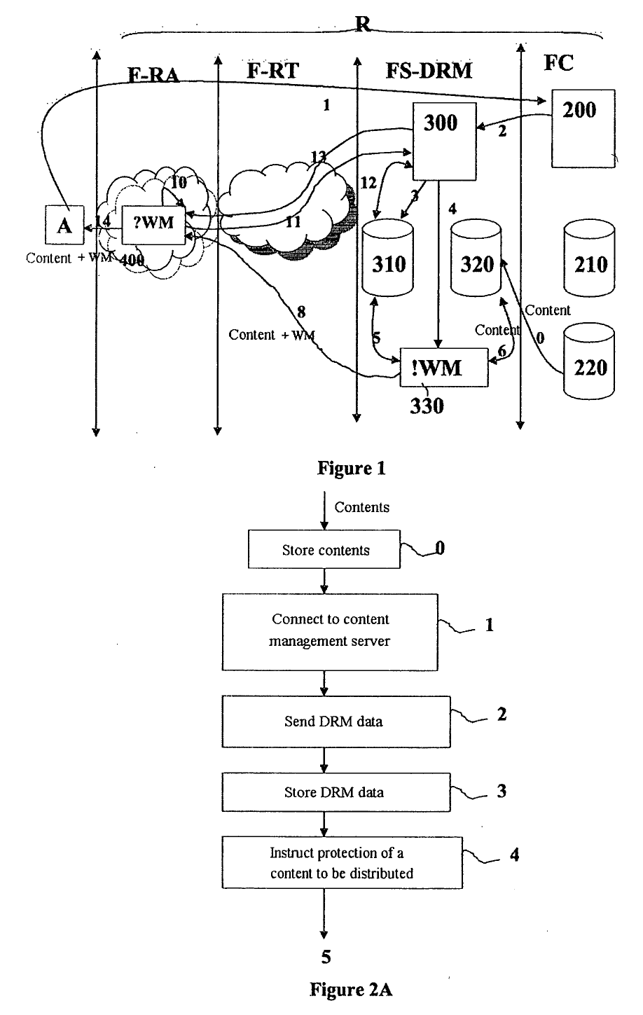

FIG. 1 is a diagram of a system for supervising the distribution of contents in a telecommunications network;

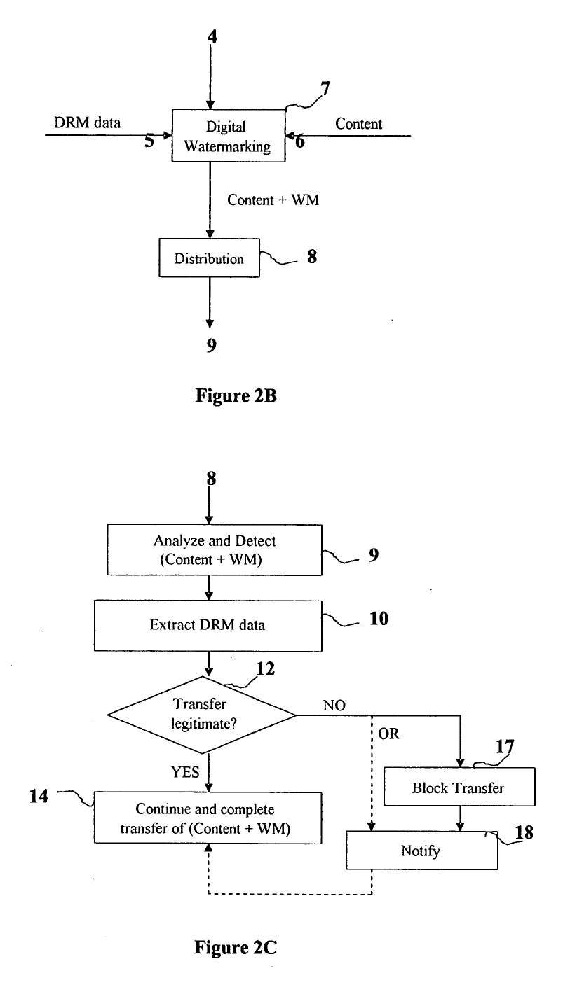

FIG. 2A is a flowchart reproducing the steps executed in the FIG. 1 network at the time of acquisition of rights to a content by an acquirer;

FIG. 2B is a flowchart reproducing the steps of protecting a content to be distributed in the FIG. 1 network;

FIG. 2C is a flowchart reproducing the steps of supervising and monitoring the legitimacy of a transfer in progress in the FIG. 1 network;

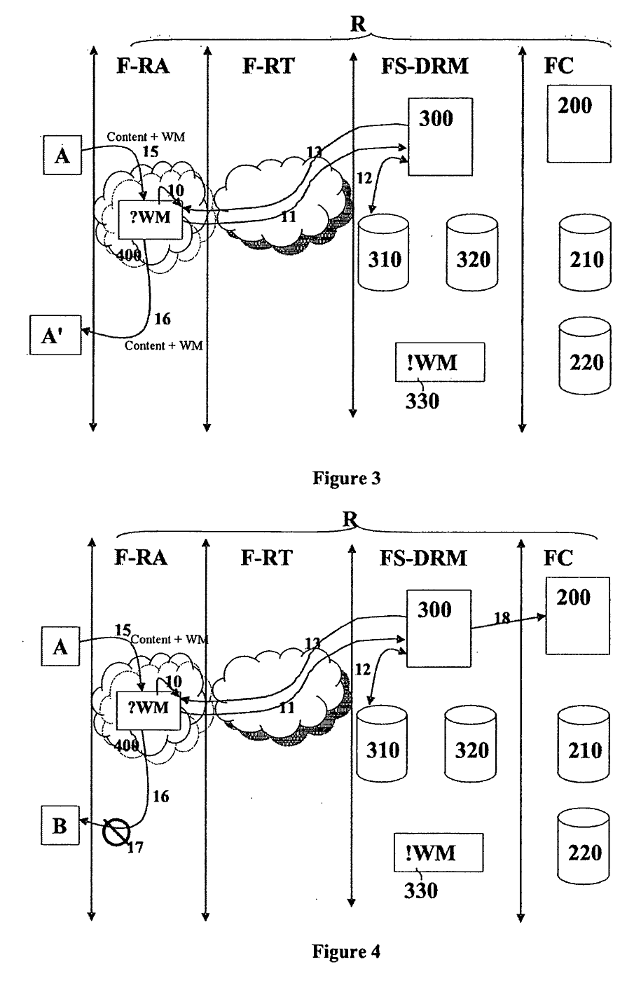

FIG. 3 is a diagram of the FIG. 1 system and of steps executed during a legitimate exchange of content between two access points;

FIG. 4 is a diagram of the FIG. 1 system and of steps executed during an illegitimate exchange of content between two access points;

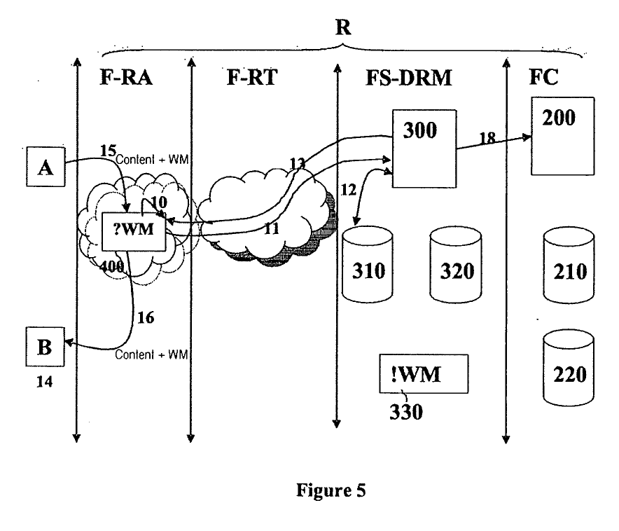

FIG. 5 is a diagram of a variant of the steps executed by the FIG. 4 system during an illegitimate exchange of content between two access points.

FIG. 1 is a diagram of a system for supervising the distribution of contents, here multimedia contents, in a telecommunications network R. In the remainder of the description, the Internet is taken as an example of a telecommunications network, it being understood, of course, that this system may be applied to other telecommunications networks.

The system represented in the FIG. 1 diagram is intended for a particular application consisting, in a first stage, in acquiring rights to a multimedia content from a content provider FC, then protecting it, and finally forwarding it to the terminal A of a user. This system is described with reference to the flowcharts of FIGS. 2A to 2C, which respectively reproduce the steps of acquiring the rights, protecting the content, and supervising forwarding of the content.

The system is made up of a plurality of elements distributed in the telecommunications network R. It comprises:
a DRM service provider FS-DRM; and
a detection probe ?WM (400), here situated in an access network RA to the network R and managed by an access resource provider F-RA.

In the example of the Internet, the access networks RA are used to connect user terminals to the telecommunications network R and to convey contents in the form of packets. IP transport resource providers F-RT thereafter convey the multimedia contents over their network in the form of IP packets. The transport network can route streams collected by an access resource provider F-RA to other access resource providers F-RA or to service providers of the network or to content providers FC of the network.

For simplicity, only one detection probe ?WM 400 is represented in FIG. 1, but clearly the number of probes in each access network RA is never limited to one. Moreover, a plurality of probes may be installed in a plurality of access networks of the same type or of different types (mobile, WLAN, fixed, fixed broadband, etc.). The probe 400 implements a mechanism for real-time detection of digital watermarks in contents. This mechanism analyzes the content during its transfer over the network R in order to detect therein the presence of a watermark and to extract from the detected watermark, on the fly (i.e. in real time during the transfer), data specific to the acquisition (DRM data or acquisition reference) contained in the watermark. The probes 400 could be in the telecommunications network R, in the core network, rather than the access network, preferably at points through which contents in transit over the network R are obliged to pass. The central supervisory equipment 300, which is managed by the DRM service provider FS-DRM, controls all the detection probes 400 associated with the various access networks RA involved in an exchange between two access points.

For simplicity, the diagram and the description refer to only one content provider FC and one access resource provider F-RA. Of course, the invention is not restricted to this very limiting circumstance, and it applies to more complex environments involving several content providers FC and several access resource providers F-RA.

The DRM service provider FS-DRM includes central supervisory equipment 300, for example of the application server type. This equipment 300 constitutes the brains of the system because it is this equipment that makes all decisions relating to a content transfer in progress.

Its role is:

to control the incorporation into a content to be distributed of data specific to a given acquisition of rights to said content; and
during transfer of the content over the network R, to obtain from a detection probe data specific to the acquisition extracted from the content, and, using that data, to assess the acquired rights to the content in a storage medium 310, in order to determine if the content transfer in progress is legitimate.

When a content provider FC wishes to obtain the benefit of a service for supervising the distribution of multimedia contents in a telecommunications network, in order to combat piracy, it initially supplies the multimedia contents that it hosts to the DRM service provider FS-DRM (step 0). To supply the contents to the DRM service provider FS-DRM, the content provider FC may feed a storage medium 320 belonging to the DRM service provider FS-DRM, for example a database, from its own storage medium 220, also a database, on which the contents are stored. Thus the DRM service provider FS-DRM has a true copy of the content database 220 of the content provider FC. Another solution is to share its database 220 with the DRM service provider FS-DRM by giving the provider a right of access thereto.

The DRM service provider FS-DRM may have a single storage medium 320 in which are stored contents from each content provider FC seeking to obtain the benefit of the supervisory service. It may equally have as many storage media 320 as there are content providers subscribing to its supervisory service.

The user of the network seeking to acquire a multimedia content connects a terminal A to the server 200 managing the contents of the content provider FC (step 1). The remote content management server 200 communicates with another database 210 containing information relating to the contents hosted by the content provider FC, for example. This information corresponds for example to a title, a synopsis, an extract, a date of publication, etc. Using this information, the user can select from the contents available on the server 200 the one to be acquired from the content provider FC. The rights acquisition process then consists in defining digital rights linking the acquirer, the acquirer's terminal A, the content provider FC, and the content. Those digital rights form part of the data known as DRM data.

The acquisition process is further enriched, compared to the standard acquisition process, in that the acquirer can indicate the context of use of the content. In particular, the acquirer can define a community of users for which the acquirer establishes rights to the content, for example to be able to exchange the content with them, the respective access networks of those users, and the terminals that will be used to download the content, etc. This additional information can be used to define rights to the content not only of the acquirer but also of other users and in respect of the various uses envisaged. An acquisition reference is also assigned for this particular acquisition of rights to the content.

All of the above information (characteristics of the content, rights to the content acquired by the acquirer and, where applicable, by other users, respective access points of the acquirer and the other users, acquisition reference, etc.), once defined between the acquirer and the content provider FC, are sent to the central equipment 300 (step 2), which stores them in the storage medium 310, which is a database, for example (step 3). This database 310 for storing information relating to acquisition of rights to contents contains in particular, for a given acquisition, characteristics relating to the content (name, description of the type of content, name of the FC) and data relating to the acquirer and/or to one or more other users, including an access point to the telecommunications network R and rights to the content. The database 310 then has a structure of the following type:
Name of content being acquired
Description of content type
Name of content provider FC
Content provider's reference for acquirer Acquisition reference
Rights of use by acquirer associated with content
List of other users authorized to use content
   List of a user's rights to content (temporal validity)
   List of accesses to content by a user
   Discriminatory network information for identifying a user on each access.

Note that the acquirer and other users for whom rights to the content have been acquired may have respective access networks to the telecommunications network R.

In the final analysis, during the acquisition process, the user and the content provider FC agree on rights to use the content conferred not only on the acquirer using the terminal A but also on other users authorized by the acquirer. All of the rights defined for a given acquisition and associated with an acquisition reference in the database 310 are specific to that acquisition and form part of the DRM data.

The content management server 200 simultaneously commands the central equipment 300 to send the terminal A the identified content file to which the acquirer has just acquired rights. However, before it is sent, the file must be protected by writing into the content to be distributed over the network data specific to the acquisition during step 1 of rights to the content. Here this data consists of the DRM data relating to the acquired digital rights to the content stored in the recording medium 310. To this end, the equipment 300 commands a watermarking module !WM (330) to incorporate a digital watermark based on the DRM data into a content to be distributed, in order to protect it (step 4). To be able to write the digital watermark WM, the module 330 recovers the DRM data associated in the database 310 with the content to be distributed (step 5) and the file associated in the database 320 with the content to be distributed (step 6). The module 330 then writes the DRM data into the file to be distributed in the form of a digital watermark WM (step 7). The digital watermark created may be associated with any content format, for example regardless of whether the content is an encrypted file or unencrypted file. Alternatively, only a portion of the DRM data, sufficient to constitute data specific to the acquisition effected in step 1, could be written into the content in the form of a watermark.

The DRM data specific to the acquisition written into the content personalizes the content by marking it with a watermark specific to a given acquisition.

The content file (Content+WM) protected in this way is then sent to the terminal A over the transport network RT and an access network RA (step 8). It may be sent directly by the watermarking module 330, as shown in FIG. 1, or by the central equipment 300 for receiving the protected content from the module 330.

The terminal A then begins to receive the content file. During this transfer across the access network RA, a probe ?WM (400) in the access network RA for detecting digital watermarks in real time analyses the file that is being forwarded as it is transferred (step 9).

During the detection step 9, the probe 400 analyses the content being transferred to detect therein an inserted digital watermark; then, during a step 10, it extracts the data specific to the acquisition that the content contains, here DRM data. During a step 11, the probe 400 then sends a signal to the central equipment 300. That signal includes DRM data extracted from the digital watermark of the content being transferred and data characteristic of the transfer in progress, here comprising the characteristics of the access network handling the transfer, the source and destination addresses of the content, the time and date, etc.

The central equipment 300 is able to access the DRM data stored on the storage medium 310 using the data that it receives. On the basis of the DRM data (characteristics of the content, users having rights to it, definition of those rights and the access networks used) and data characteristic of the transfer in progress, the central equipment 300 determines if the transfer in progress is legitimate (step 12). It can then send a message to the detection probe 400 (step 13). That message may be an instruction to continue the transfer in progress or an instruction to interrupt the transfer in progress, for example.

In the example shown in FIG. 1, the transfer in progress is legitimate, the user of the terminal A having acquired rights to the content beforehand. The message 13 therefore confirms to the detection probe 400 that it should allow the transfer to be effected normally. Finally, the content is stored on the terminal A of the user when the transfer is completed (step 14).

This system enables the user of the terminal A to benefit from the flexibility of telecommunications networks. Thus the user can use different types of access network (mobile, WLAN, fixed, fixed broadband, etc.) and terminals of different kinds to access contents and/or to redistribute contents in accordance with the rights acquired from the content provider FC. The system therefore enables the user to access contents, to redistribute them, even when roaming and not accessing the telecommunications network via the user's usual line.

The steps executed by the supervisory system during a later legitimate exchange between two access points are shown in the FIG. 3 diagram. A user thus transfers a multimedia content to which rights have been acquired from a content provider FC from the user's terminal A to another of the user's terminals A′, which is connected to another access network RA for which rights were also acquired rights during the acquisition phase. Similarly, the user might wish to send the file to a member of the user's own family circle or to a clearly delimited circulation list, for which the necessary transmission rights were acquired during the acquisition phase.

During a first step 15, the terminal A initiates the sending of the protected file (Content+WM) to the other terminal A′.

In the next step 16, the terminal A′ begins to receive the file.

The steps 10 to 13 as described above with reference to FIGS. 1 and 2C are then executed. The transfer being legitimate, the message 13 sent by the central supervisory equipment 300 to the detection mechanism 400 confirms thereto that it should allow the transfer to continue normally.

Finally, the legitimate transfer continues and is completed normally. The file is then stored on the terminal A′ (step 14).

The FIG. 4 diagram shows the steps executed by the supervisory system during a subsequent illegitimate exchange between two access points.

In the step 15, the user of the terminal A initiates the sending of a protected file (Content+WM) to which rights have previously been acquired from a content provider FC to the terminal B of another user for whom no rights to the file have been acquired. Transferring this content to the terminal B is therefore fraudulent.

In the next step 16, the terminal B begins to receive the file.

The steps 10 to 12 as described above with reference to FIGS. 1 and 2C are then executed.

On comparing the data received from the detection probe 400 and the data stored in the storage medium 310, the central supervisory equipment 300 finds that the transfer is illegitimate. Under such circumstances, in the step 13, the central equipment 300 informs the probe 400 of the access network RA that the transfer must be interrupted.

In the step 17 (see FIGS. 4 and 2C), the detection mechanism 400 of the access resource provider F-RA commands the access network RA to block the traffic of the stream concerned. The transfer is terminated and fails. Only a portion of the file has been stored in the terminal B.

Finally, in the step 18 (see FIGS. 4 and 2C), the central equipment 300 notifies the content provider FC concerned that one of its acquirers has attempted to transfer a content to which that acquirer had acquired rights to another user having no such rights.

FIG. 5 is a diagram of a variant of the steps executed by the supervisory system during a subsequent illegitimate transfer between two access points.

Under these circumstances, the steps 15, 16 and 10 to 12 are executed as described above with reference to FIG. 4.

In the step 18 (see FIGS. 5 and 2C), the central equipment 300 sends a notification to the content provider FC concerned to the effect that one of its acquirers has initiated the transfer of a content to which that user has acquired rights to another user having no such rights. However, the illegitimate transfer is not blocked as such, but instead continues and terminates normally (step 14). The file is therefore stored in the terminal B. The operation has nevertheless been traced and the content provider FC who has suffered harm can then instigate recovery proceedings against the incriminated persons responsible.

In a complex environment with multiple access networks, the central equipment 300 of the DRM service provider FS-DRM receives DRM data from various detection probes 400 of the various access resource providers F-RA. For n providers F-RA involved in the exchange between two access points, the central equipment 300 is therefore potentially interfaced to at least n detection probes 400 associated with respective providers F-RA. Processing complexity is nevertheless limited by means of implementing a common format for the signals 11 fed back to the central equipment 300 and containing the DRM data of the watermark incorporated in the file. This enables the DRM service provider FS-DRM to detect information relating to the same exchange, and the analysis of the data is then identical to that of the single F-RA situation described above.

The method and the system described above provide a very effective way to check the phenomena of fraudulent file transfers, regardless of the network architectures. They also address the constraints imposed by a complex environment with multiple access networks. It is in fact possible to exchange contents and to view them independently of the nature of the terminals used and to modify the rights to the contents independently of the nature of the access networks handling the transfers. Note that rights in the database 310 of the DRM service provider can be modified only by the content providers, and not by the users themselves, who have no access whatsoever to the equipment of the DRM service provider. For this, the content provider seeking to modify rights connects to the central equipment 300 and sends it a request for modification of the database 310. The content providers thus retain control over the contents and the knowledge of their use.

Moreover, decorrelating the management of multimedia contents from the protection of multimedia contents and monitoring the rights associated with each content avoids the proliferation of DRM systems in the networks and of situations in which each content provider FC implements a specific DRM system, with specific software. This decorrelation also has the advantage of simplifying maintenance of the installed software, optimizing memory capacity, and enabling centralized management of a database 310 containing in particular the rights of users.

Moreover, illegitimate transfer detection is no longer effected a posteriori but in real time, during the transfer, and the actions that are required, such as notifying the content provider FC and/or interrupting the transfer, for example, may be carried out in real time. The content provider receiving an illegitimate transfer notification can then pursue the identified pirates.

Finally, illegitimate transfer detection is entirely transparent vis-à-vis the end user, who has no means of knowing if the content being transferred or received is protected and if its distribution is being monitored. This system therefore constitutes a highly effective disincentive and a highly effective way to combat piracy.

In the above description, the content is protected by writing DRM data specific to a given acquisition of rights to the content. Instead of DRM data, there could be written into the content an acquisition reference assigned in a manner specific to the acquisition of rights to that content by an acquirer from a content provider FC. The acquisition reference is stored in the storage medium 310 in association with the DRM data. This kind of acquisition reference provides unique access to a record corresponding to a given acquisition of rights to a content in the storage medium 310.

Writing data specific to the acquisition (DRM data or acquisition reference) in the content by means other than a digital watermark may equally be envisaged, preferably in a manner that is imperceptible to the receiver of the content.

1. A method of supervising the distribution of content in a telecommunications network when data specific to a given acquisition of rights to the content has been written therein, wherein the method comprises processing of the content during its transfer over the telecommunications network by:
analyzing the content and extracting the data specific to said acquisition therefrom with the aid of a detection probe situated in the telecommunications network;
accessing the acquired rights to the content in a storage medium with the aid of the extracted data specific to the acquisition; and
determining if the transfer of the content in progress is legitimate.

2. The method according to claim 1, further comprising a step of sending the data specific to the acquisition extracted from the content and data characteristic of the transfer in progress from the probe to central supervisory equipment of the telecommunications network to determine the legitimacy of the transfer in progress.

3. The method according to claim 1, wherein the step of analyzing the content and extracting therefrom the data specific to the acquisition is executed in an access network of the telecommunications network.

4. The method according to claim 3, wherein the data characteristic of the transfer in progress includes characteristics of the access network.

5. The method according to claim 1, wherein, during the process of acquisition of rights to said content from a content provider, the acquirer chooses said content and defines rights to said content for a user, after which the rights defined between the acquirer and the content provider are sent to central supervisory equipment, which stores them in said storage medium.

6. The method according to claim 5, wherein the rights to the content defined between the acquirer and the content provider are associated with characteristics of the content in the storage medium, the combination of the rights to the content and the characteristics of the content constituting DRM data, and the method further comprising a step of protecting the content executed by the central supervisory equipment in which at least some of said DRM data is written in the content.

7. The method according to claim 5, wherein the rights to the content defined between the acquirer and the content provider are associated in the storage medium with an acquisition reference and the method further comprises a step of protecting the content executed by the central supervisory equipment in which said acquisition reference is written in the content.

8. The method according to claim 5, further comprising, if the transfer of the content is illegitimate, a step of establishing a notification of the illegitimate transfer and sending it to the content provider.

9. The method according to claim 1, further comprising, if the transfer of the content is illegitimate, a step of commanding an access network of the telecommunications network to block the illegitimate transfer in progress.

10. The method according to claim 1, wherein the data specific to the acquisition is written in the content in the form of a digital watermark.

11. A detection probe for a telecommunications network, adapted to implement a detection mechanism consisting, during a transfer over said network of a content in which data specific to a given acquisition of rights to said content has been written, analyzing the content and extracting therefrom the data specific to the acquisition.

12. The probe according to claim 11, and further adapted to send to a central supervisory equipment of the telecommunications network the extracted data specific to the acquisition and data characteristic of the transfer in progress.

13. Central equipment for supervising a distribution of contents in a telecommunications network, adapted:
to monitor the incorporation into a content to be distributed of data specific to a given acquisition of rights to said content; and
during transfer of the content over the network, to obtain from a detection probe the data specific to the acquisition extracted from the content and with the aid of that data to access the acquired rights to the content in a storage medium in order to determine if the transfer of the content in progress is legitimate.

14. The central supervisory equipment according to claim 13, further adapted to receive the acquired rights to the content as defined between the acquirer and a content provider and to store them in the storage medium.

15. A storage medium for storing data relating to acquisition of rights to contents comprising, for a given acquisition, characteristics relating to the content and data relating to the acquired rights to the content comprising, for a user, an access point to the telecommunications network and rights to the content.

16. The storage medium according to claim 14, further comprising, for a given acquisition, an acquisition reference.

17. A service provider of a telecommunications network, comprising:
central supervisory equipment according to one of claim 13 and claim 14 situated in the telecommunications network;
a storage medium for data relating to acquisition of rights to contents; and
a watermarking module adapted to write data specific to a given acquisition of rights to a content in said content to be distributed on the basis of data stored in said storage medium.

18. The service provider according to claim 17, comprising a content storage medium adapted to store contents provided by a content provider.

19. A system for supervising a distribution of contents in a telecommunications network, comprising:
a service provider according to one of claim 17 and claim 18; and
a detection probe according to one of claim 11 and claim 12.

20. A system according to claim 19, further comprising a plurality of detection probes according to at least one of claim 11 and claim 12 respectively situated in a plurality of access networks of the telecommunications network.

21. A content adapted to be distributed in a telecommunications network into which is incorporated data specific to an acquisition of rights to said content.

22. A signal coming from a probe according to claim 11, said signal being intended for central equipment for supervising the distribution of contents in a communication network, characterized in that the signal includes data specific to an acquisition of rights to said content extracted from the content and data characteristic of a transfer in progress of the content over the network.

23. A signal coming from a probe according to claim 12, said signal being intended for central equipment for supervising the distribution of contents in a communication network, characterized in that the signal includes data specific to an acquisition of rights to said content extracted from the content and data characteristic of a transfer in progress of the content over the network
